(19) United States
(12) Patent Application Publication
(10) Pub. No.: US 2022/0340141 A1
(43) Pub. Date: Oct. 27, 2022

(54) APPARATUS FOR STARTING ENGINE OF HYBRID VEHICLE AND METHOD THEREOF

(71) Applicants: Hyundai Motor Company, Seoul (KR); Kia Corporation, Seoul (KR)

(72) Inventor: Chang Hyun HA, Seoul (KR)

(73) Assignees: Hyundai Motor Company, Seoul (KR); Kia Corporation, Seoul (KR)

(21) Appl. No.: 17/484,150

(22) Filed: Sep. 24, 2021

(30) Foreign Application Priority Data
Apr. 22, 2021 (KR) 10-2021-0052536

(51) Int. Cl. B60W 30/192; B60W 10/06; B60W 10/08; B60K 6/485

(52) U.S. Cl. CPC B60W 30/192; B60W 10/06; B60W 10/08; B60K 6/485; B60K 2006/268

(57) ABSTRACT

An apparatus of starting an engine for a hybrid vehicle may include an engine configured for generating power by combustion of a fuel; a starting motor configured for starting the engine; a hybrid starter-generator configured for starting the engine, selectively operating as a generator, and selectively operating as a torque auxiliary device of a drive motor; and a controller configured for selectively performing a first starting mode to start the engine using the hybrid starter-generator according to a coolant temperature, a second starting mode to start the engine using the starting motor, and a third starting mode to start the engine using the starting motor and the hybrid starter-generator according to the coolant temperature.

### CROSS-REFERENCE TO RELATED APPLICATION

The present application claims priority to Korean Patent Application No. 10-2021-0052536 filed on Apr. 22, 2021, the entire contents of which is incorporated herein for all purposes by this reference.

### BACKGROUND OF THE INVENTION

### Field of the Invention

The present invention relates to an apparatus of starting an engine of a hybrid vehicle and a method. More particularly, the present invention relates to an apparatus for starting an engine of a hybrid vehicle and a method thereof for starting an engine by use of two starting apparatuses (e.g., a starting motor and a starter-generator).

### Description of Related Art

A hybrid vehicle is a vehicle that utilizes two or more power sources, and generally refers to a hybrid electric vehicle driven using an engine and a motor. The hybrid electric vehicle may form various structures by use of two or more power sources including the engine and the motor.

A clutch is provided between the engine and the drive motor, and depending on whether the clutch is engaged, the hybrid electric vehicle is operated in an EV (Electric Vehicle) mode or an HEV (Hybrid Electric Vehicle) mode. The EV mode is a mode in which the vehicle runs only with the driving torque of the drive motor, and the HEV mode is a mode in which the vehicle runs with the driving torque of the drive motor and the engine.

Conventionally, the engine applied to the hybrid vehicle is started using the starting motor or the starter-generator. However, there is a problem in that the capacity of the starting motor or starter-generator had to be increased to start the engine when the external temperature is low, such as in winter.

The information included in this Background of the Invention section is only for enhancement of understanding of the background of the invention and may not be taken as an acknowledgement or any form of suggestion that this information forms the prior art already known to a person skilled in the art.

### BRIEF SUMMARY

Various aspects of the present invention are directed to providing an apparatus of starting an engine for a hybrid vehicle which may reduce a capacity and price of the starting motor by starting the engine for the hybrid vehicle using the starting motor and the hybrid starter-generator

An apparatus of starting an engine for a hybrid vehicle according to various exemplary embodiments of the present invention includes: an engine configured for generating power by combustion of a fuel; a starting motor configured for starting the engine; a hybrid starter-generator configured for starting the engine, selectively operating as a generator, and selectively as an operating torque auxiliary device of the drive motor; and a controller configured for selectively performing a first starting mode to start the engine using the hybrid starter-generator according to a coolant temperature, a second starting mode to start the engine using the starting motor, and a third starting mode to start the engine using the starting motor and the hybrid starter-generator according to the coolant temperature.

The controller may perform the first starting mode when the coolant temperature is a first predetermined temperature or higher than the first predetermined temperature, performs the second starting mode when the coolant temperature is between the first predetermined temperature and a second predetermined temperature, and performs the third starting mode when the coolant temperature is less than the second predetermined temperature.

In the first starting mode, when a starting request of a driver is input, the controller may start the engine through the hybrid starter-generator.

The driving torque of the hybrid starter-generator may be determined based on the coolant temperature and an engine speed.

The driving torque of the hybrid starter-generator may increase as the coolant temperature decreases, and may decrease as the engine speed increases.

In the third starting mode, when the starting request of the driver is input, the controller may operate the starting motor to start the engine, and may assist the starting of the engine through the hybrid starter-generator after a predetermined time period.

The predetermined time period may be determined according to the coolant temperature.

The predetermined time period may be shorter as the coolant temperature is lower.

The driving torque of the hybrid starter-generator may be determined according to the coolant temperature and an engine speed.

The driving torque of the hybrid starter-generator may increase as the coolant temperature decreases, and may decrease as the engine speed increases.

A method of starting an engine for a hybrid vehicle according to various exemplary embodiments of the present invention includes: detecting a starting request of a driver; detecting a coolant temperature when the starting request of the driver is detected; and selectively performing a first starting mode to start the engine using a hybrid starter-generator according to a coolant temperature, a second starting mode to start the engine using a starting motor, and a third starting mode to start the engine using the starting motor and the hybrid starter-generator according to the coolant temperature.

When the coolant temperature is a first predetermined temperature or higher than the first predetermined temperature, the first starting mode may be performed, when the coolant temperature is between the first predetermined temperature and the second predetermined temperature, the second starting mode may be performed, and when the coolant temperature is less than the second predetermined temperature, the third starting mode may be performed.

In the first starting mode, the driving torque of the hybrid starter-generator may be determined, and the engine may start through the driving torque of the hybrid starter-generator.

The driving torque of the hybrid starter-generator may be determined according to the coolant temperature and an engine speed.

The driving torque of the hybrid starter-generator may increase as the coolant temperature decreases, and may decrease as the engine speed increases.

The method of starting the engine for the hybrid vehicle according to various exemplary embodiments of the present invention may further include, in the third starting mode: operating the starting motor to start the engine; and operating the hybrid starter-generator after a predetermined time period to assist the starting of the engine.

The predetermined time period may be determined according to the coolant temperature.

The predetermined time period may be shorter as the coolant temperature is lower.

The driving torque of the hybrid starter-generator may be determined according to the coolant temperature and an engine speed.

The driving torque of the hybrid starter-generator may increase as the coolant temperature decreases, and may decrease as the engine speed increases.

According to the apparatus of starting the engine for the hybrid vehicle and the method thereof according to various exemplary embodiments of the present invention, by cooperatively controlling the starting motor and the hybrid starter-generator based on the coolant temperature, the capacity of the starting motor may be reduced and the manufacturing cost of the vehicle may be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view showing a configuration of an engine for a hybrid vehicle according to various exemplary embodiments of the present invention.

FIG. 2 is a block diagram showing a configuration of an apparatus of starting an engine for a hybrid vehicle according to various exemplary embodiments of the present invention.

FIG. 3 is a flowchart showing a starting method of an engine for a hybrid vehicle according to various exemplary embodiments of the present invention.

FIG. 4 is a graph for explaining a starting process of an engine for a hybrid vehicle according to various exemplary embodiments of the present invention.

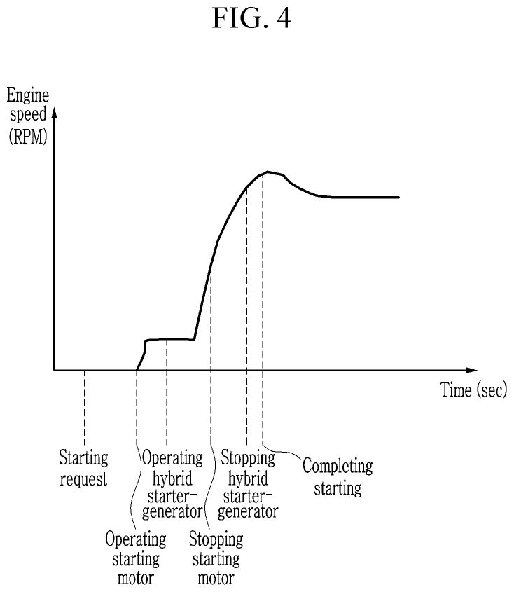

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Exemplary embodiments of the present application will be described more fully hereinafter with reference to the accompanying drawings, in which embodiments of the present invention are shown. As those skilled in the art would realize, the described embodiments may be modified in various different ways, all without departing from the spirit or scope of the present invention.

The drawings and description are to be regarded as illustrative in nature and not restrictive. Like reference numerals designate like elements throughout the specification.

Furthermore, in the drawings, a size and thickness of each element are arbitrarily represented for better understanding and ease of description, and the present invention is not limited thereto.

Hereinafter, an apparatus of starting an engine for a hybrid vehicle according to various exemplary embodiments of the present invention is described in detail with reference to accompanying drawings.

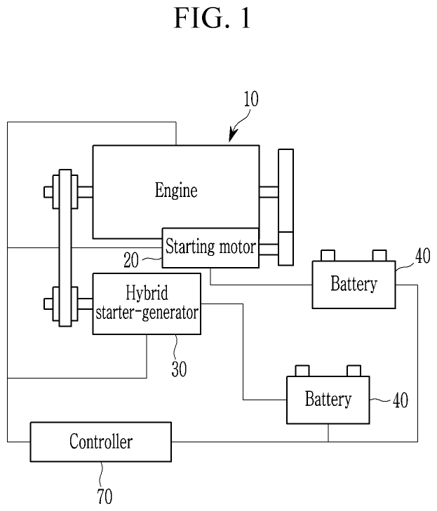

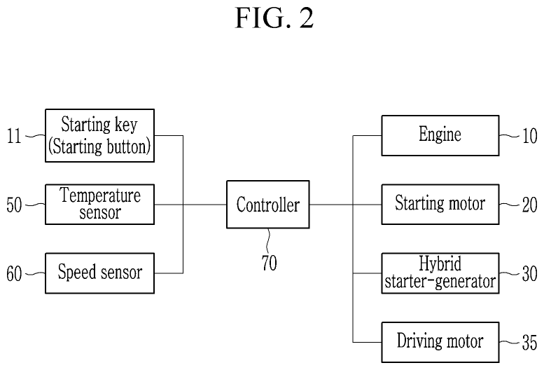

FIG. 1 is a schematic view showing a configuration of an engine for a hybrid vehicle according to various exemplary embodiments of the present invention. FIG. 2 is a block diagram showing a configuration of an apparatus of starting an engine for a hybrid vehicle according to various exemplary embodiments of the present invention.

As shown in FIG. 1 and FIG. 2, a hybrid vehicle according to various exemplary embodiments of the present invention may include an engine 10, a starting motor 20, a starter-generator 30, a battery 40 and a controller 70 configured for controlling the engine 10, the starting motor 20, the starter-generator 30 and a driving motor 35.

The engine generates power required to drive the vehicle by fuel combustion.

The starting motor starts the engine and may be gear-engaged with a flywheel of the engine.

The starter and generator (HSG: hybrid starter-generator) starts the engine together with the starting motor and selectively operates as a generator to generate electrical energy. The hybrid starter-generator is coupled with the engine through a pulley. The hybrid starter-generator may be operated as a torque auxiliary device for the drive motor 40 if required.

The starting motor and the hybrid starter-generator operate using the electrical energy stored in the battery 40 provided in the vehicle, and the electrical energy generated by the hybrid starter-generator is charged to the battery.

The engine according to various exemplary embodiments of the present invention may include a temperature sensor 50 and a speed sensor 60. The temperature sensor detects a coolant temperature, and the coolant temperature detected by the temperature sensor is transmitted to the controller. The speed sensor detects the engine speed, and the engine speed detected by the speed sensor is transmitted to the controller.

The controller selectively performs a first starting mode to start the engine using the hybrid starter-generator based on the coolant temperature, a second starting mode to start the engine using the starting motor, and a third mode starting motor to start the engine using the starting motor and the hybrid starter-generator.

To the present end, the controller may be provided with at least one processor operated by a predetermined program, and the predetermined program is configured to perform each step of a method of starting the engine for the hybrid vehicle according to various exemplary embodiments of the present invention.

Hereinafter, the method of starting the engine for the hybrid vehicle according to an exemplary embodiment of the present invention is described in detail with accompanying drawings.

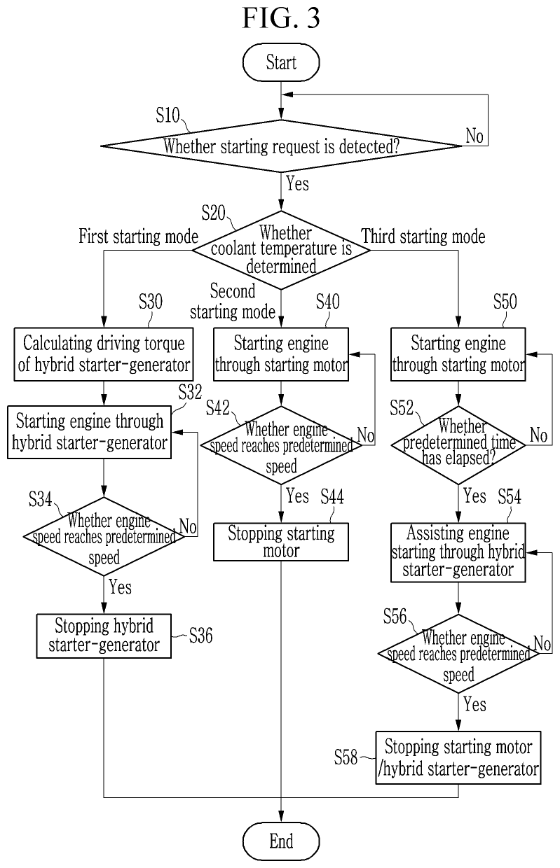

FIG. 3 is a flowchart showing a starting method of an engine for a hybrid vehicle according to various exemplary embodiments of the present invention.

As shown in FIG. 3, if a starting request of a driver is input (S10), the temperature sensor detects the coolant temperature and transmits it to the controller. When the driver moves the starting key 11 to the starting position or presses the starting button, it may be determined that the starting request of the driver is input.

The controller selectively performs any one starting mode among the first starting mode to the third starting mode based on the coolant temperature S20.

In various exemplary embodiments of the present invention, the first starting mode may be a mode that starts the engine using only the hybrid starter-generator, the second starting mode may be a mode that starts the engine using only the starting motor, and the third starting mode may be a mode that starts the engine using the starting motor and the hybrid starter-generator.

<The First Starting Mode>

If the coolant temperature is above the first predetermined temperature (e.g., 0 degrees Celsius), the controller may perform the first starting mode. If the coolant temperature is between the first predetermined temperature (e.g., 0 degrees Celsius) and the second predetermined temperature (e.g., minus 10 degrees Celsius), the controller may perform the second starting mode. If the coolant temperature is less than the second predetermined temperature, the controller can perform the third starting mode.

If the coolant temperature is higher than the first predetermined temperature, the controller is configured to determine the driving torque of the hybrid starter-generator to start the engine (S30) and starts the engine using only the hybrid starter-generator (S32). At the instant time, the controller is configured to determine the driving torque of the hybrid starter-generator based on the engine speed and the coolant temperature. As shown in Table 1 below, the driving torque of the hybrid starter-generator may increase as the coolant temperature decreases, and may decrease as the engine speed increases.

TABLE 1

| | 0 | 200 | 400 | 600 | 690 | 700 | 1000 | 1100 |
|---|---|---|---|---|---|---|---|---|
| −30 | 140 | 140 | 140 | 80 | 60 | 0 | 0 | 0 |
| −20 | 140 | 140 | 140 | 80 | 60 | 0 | 0 | 0 |
| −10 | 140 | 140 | 140 | 80 | 60 | 0 | 0 | 0 |
| 0 | 140 | 140 | 140 | 80 | 60 | 0 | 0 | 0 |
| 10 | 140 | 140 | 140 | 80 | 60 | 0 | 0 | 0 |
| 20 | 140 | 140 | 140 | 80 | 60 | 0 | 0 | 0 |
| 50 | 140 | 140 | 140 | 80 | 60 | 0 | 0 | 0 |
| 80 | 140 | 140 | 140 | 80 | 60 | 0 | 0 | 0 |
| 90 | 140 | 140 | 140 | 80 | 60 | 0 | 0 | 0 |

In Table 1, a horizontal axis means an engine speed (RPM), and a vertical axis means a coolant temperature (Celsius temperature).

For example, when the starting request of the driver is detected, the controller is configured to operate the hybrid starter-generator by setting the initial driving torque of the hybrid starter-generator as 140 Nm. Also, as the engine speed gradually increases, the starting torque of the hybrid starter-generator is gradually reduced.

When the engine speed reaches a predetermined speed (e.g., 1000 rpm) (S34), the controller is configured to determine that the starting is complete and stops the operation of the hybrid starter-generator (S36).

<The Second Starting Mode>

When the coolant temperature is between the first predetermined temperature and the second predetermined temperature, the controller is configured to operate the starting motor to start the engine (S40).

When the engine speed reaches a predetermined speed (e.g., 1000 rpm) (S42), the controller is configured to determine that the starting is complete and stops the operation of the starting motor (S44).

<The Third Starting Mode>

If the coolant temperature is less than the second predetermined temperature, the controller is configured to operate the starting motor to start the engine (S50).

After the starting motor is operated, the controller is configured to determine whether a predetermined time period has elapsed (S52), and when the predetermined time period has elapsed, the controller is configured to operate the hybrid starter-generator to assist the starting of the engine (S54).

The predetermined time period may be determined according to the coolant temperature. For example, as shown in Table 2 below, the predetermined time period may be set to become shorter as the coolant temperature decreases.

TABLE 2

| X | −40 | −20 | −10 | 0 | 10 | 20 | 40 | 60 | 80 | 100 |
|---|---|---|---|---|---|---|---|---|---|---|
| Y | 0.2 | 0.2 | 2.5 | 2.5 | 2.5 | 2.5 | 2.5 | 2.5 | 2.5 | 2.5 |

In Table 2, the row X means the coolant temperature (Celsius temperature), and the row Y means the predetermined time period (s).

For example, when the coolant temperature is minus 20 degrees, the hybrid starter-generator operates 0.2 seconds after the starting motor operates.

At the present time, the controller is configured to determine the driving torque of the hybrid starter-generator to assist the starting motor and operates the hybrid starter-generator according to the determined driving torque to assist the engine starting. As shown in Table 3 below, the driving torque of the hybrid starter-generator may increase as the coolant temperature decreases, and may decrease as the engine speed increases.

TABLE 3

| | 0 | 200 | 400 | 600 | 690 | 700 | 1000 | 1100 |
|---|---|---|---|---|---|---|---|---|
| −30 | 40 | 40 | 40 | 35 | 30 | 0 | 0 | 0 |
| −20 | 30 | 30 | 30 | 25 | 20 | 0 | 0 | 0 |
| −10 | 0 | 0 | 0 | 0 | 0 | 0 | 0 | 0 |
| 0 | 0 | 0 | 0 | 0 | 0 | 0 | 0 | 0 |
| 10 | 0 | 0 | 0 | 0 | 0 | 0 | 0 | 0 |
| 20 | 0 | 0 | 0 | 0 | 0 | 0 | 0 | 0 |
| 50 | 0 | 0 | 0 | 0 | 0 | 0 | 0 | 0 |
| 80 | 0 | 0 | 0 | 0 | 0 | 0 | 0 | 0 |
| 90 | 0 | 0 | 0 | 0 | 0 | 0 | 0 | 0 |

In Table 1, the horizontal axis means the engine speed (RPM), and the vertical axis means the coolant temperature (Celsius temperature).

For example, it may be set that the coolant temperature is minus 20 degrees Celsius, the starting motor operates and then the engine speed is 400 revolutions per minute (RPM) after 0.2 seconds, and the driving torque of the hybrid starter-generator is 30 Nm. As the engine speed gradually increases, the starting torque of the hybrid starter-generator may be gradually reduced.

When the engine speed reaches the predetermined speed (e.g., 1000 rpm) (S56), the controller is configured to determine that the starting is complete and stops the operation of the hybrid starter-generator (S58).

According to the apparatus of starting the engine for the hybrid vehicle and the method thereof according to various exemplary embodiments of the present invention as described above, by cooperatively controlling the starting motor and the hybrid starter-generator based on the coolant temperature, the capacity of the starting motor may be reduced and the manufacturing cost of the vehicle may be reduced.

In the cold starting, the starting performance may be improved through the cooperative control of the starting motor and the hybrid starter-generator.

Also, the starting efficiency may be improved by starting the engine by selectively using the starting motor and hybrid starter-generator according to the coolant temperature.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

1. An apparatus for starting an engine of a hybrid vehicle, the apparatus comprising:
an engine configured for generating power by combustion of a fuel;
a starting motor configured for starting the engine;
a hybrid starter-generator configured for starting the engine, selectively operating as a generator, and selectively operating as a torque auxiliary device of a drive motor; and
a controller configured for selectively performing a first starting mode to start the engine using the hybrid starter-generator according to a coolant temperature, a second starting mode to start the engine using the starting motor, and a third starting mode to start the engine using the starting motor and the hybrid starter-generator according to the coolant temperature,
wherein the controller is configured:
to perform the first starting mode when the coolant temperature is a first predetermined temperature or higher than the first predetermined temperature;
to perform the second starting mode when the coolant temperature is between the first predetermined temperature and a second predetermined temperature; and
to perform the third starting mode when the coolant temperature is less than the second predetermined temperature, and
wherein the second predetermined temperature is lower than the first predetermined temperature.

2. (canceled)

3. The apparatus of claim 1, wherein in the first starting mode, when a starting request of a driver is input, the controller is configured to start the engine through the hybrid starter-generator.

4. The apparatus of claim 3, wherein a driving torque of the hybrid starter-generator is determined according to the coolant temperature and an engine speed.

5. The apparatus of claim 4, wherein the driving torque of the hybrid starter-generator increases as the coolant temperature decreases, and decreases as the engine speed increases.

6. The apparatus of claim 1, wherein in the third starting mode, when a starting request of a driver is input, the controller is configured to operate the starting motor to start the engine, and to assist the starting of the engine through the hybrid starter-generator after a predetermined time period.

7. The apparatus of starting the engine of the hybrid vehicle of claim 6, wherein the predetermined time period is determined according to the coolant temperature.

8. The apparatus of claim 7, wherein the predetermined time period is shorter as the coolant temperature is lower.

9. The apparatus of claim 6, wherein a driving torque of the hybrid starter-generator is determined according to the coolant temperature and an engine speed.

10. The apparatus of claim 9, wherein the driving torque of the hybrid starter-generator increases as the coolant temperature decreases, and decreases as the engine speed increases.

11. A method for starting an engine of a hybrid vehicle, the method comprising:
detecting a starting request of a driver;
detecting a coolant temperature when the starting request of the driver is detected; and
selectively performing, by a controller, a first starting mode to start the engine using a hybrid starter-generator according to a coolant temperature, a second starting mode to start the engine using a starting motor, and a third starting mode to start the engine using the starting motor and the hybrid starter-generator according to the coolant temperature,
wherein
when the coolant temperature is a first predetermined temperature or higher than the first predetermined temperature, the first starting mode is performed,
when the coolant temperature is between the first predetermined temperature and a second predetermined temperature, the second starting mode is performed, and
when the coolant temperature is less than the second predetermined temperature, the third starting mode is performed, and
wherein the second predetermined temperature is lower than the first predetermined temperature.

12. (canceled)

13. The method of starting the engine of the hybrid vehicle of claim 11, wherein
in the first starting mode, a driving torque of the hybrid starter-generator is determined, and the engine starts through the driving torque of the hybrid starter-generator.

14. The method of claim 13, wherein a driving torque of the hybrid starter-generator is determined according to the coolant temperature and an engine speed.

15. The method of claim 14, wherein the driving torque of the hybrid starter-generator increases as the coolant temperature decreases, and decreases as the engine speed increases.

16. The method of claim 11, wherein in the third starting mode:
the starting motor operates to start the engine; and
the hybrid starter-generator operates after a predetermined time period to assist the starting of the engine.

17. The method of claim 16, wherein the predetermined time period is determined according to the coolant temperature.

18. The method of claim 17, wherein the predetermined time period is shorter as the coolant temperature is lower.

19. The method of claim 16, wherein a driving torque of the hybrid starter-generator is determined according to the coolant temperature and an engine speed.

20. The method of claim 19, wherein the driving torque of the hybrid starter-generator increases as the coolant temperature decreases, and decreases as the engine speed increases.
